(19) United States
(12) Patent Application Publication
(10) Pub. No.: US 2026/0194132 A1
(43) Pub. Date: Jul. 9, 2026

(54) WAVE GENERATOR

(71) Applicant: AKTIEBOLAGET SKF, GOTEBORG (SE)

(72) Inventors: Ingo SCHULZ, Gerolzhofen (DE); Lijun CAO, Houten (NL); Tilmann HAAR, Hassfurt (DE)

(21) Appl. No.: 19/133,945

(22) PCT Filed: Dec. 8, 2022
(86) PCT No.: PCT/EP2022/084981

§ 371 Date: May 29, 2025

(51) Int. Cl. F16H 49/00; F16C 19/16; F16C 33/58

(52) U.S. Cl. CPC F16H 49/001; F16C 19/163; F16C 33/585; F16C 2361/61; F16H 2049/003

(57) ABSTRACT

A strain wave gearing includes a wave generator, a deformable cylindrical ring with external teeth arranged around the wave generator and a rigid cylindrical outer ring with internal teeth meshed with the external teeth. The wave generator includes oval inner and outer rings each having a raceway and a plurality of balls between the raceways, and the wave generator is notionally divided in cross-section by an axis of rotation of a ball and an axis perpendicular to the axis of rotation of the ball into four quadrants. The ball has two contact points with each raceway each of which lies in one of the four quadrants, and a center of a radius of curvature of each raceway lies in an opposite quadrant. The contact points are offset from and located in a range of ±10° from the axis perpendicular to the axis of rotation of the ball.

The present invention relates to a wave generator for a strain wave gearing having an oval inner ring and an oval outer ring according to claim 1. Furthermore, the present invention relates to a strain wave gearing having such a wave generator according to claim 9.

Strain wave gearings, also called harmonic gearings, are a type of high-precision gears, which may be used, for example, in joints of articulated robots. Strain wave gearings consist of a wave generator, which is arranged in an elastically deformable cup or bushing or even an elastically deformable cylinder (the so-called “flex spline”), which in turn is surrounded by a cylindrical outer ring (the so-called “circular spline”). The bushing has external teeth and is elastically deformable in an oval shape, so that the external teeth of the bushing mesh with the internal teeth of the cylindrical outer ring at two opposite points. The ovality of the bushing is created by the oval shape of the wave generator. The wave generator or shaft generator represents a bearing with an oval or elliptical shape instead of a round shape.

Since the bearing or wave generator is constantly deformed, particularly the outer ring, which is in contact with the oval bushing, experiences a dynamically changing deformation at all points on the ring. The rings of the wave generator are therefore subjected to high loads, which increases both the risk of failure and the need for very high material grades. At the same time, the bearing must run under preload to ensure a minimum difference between the rotation of the inner ring of the wave generator, which is driven from the outside, and the outer ring of the wave generator, which drives the oval bushing.

Up to now, deep groove ball bearings have usually been used in wave generators. However, centrifugal forces can lead to increased sliding. Since there are only two contact points between the balls and the raceways, this can lead to a high contact pressure. The two contact points between the balls and the raceways change with the load direction, which causes a dynamic change of the axis of rotation of the ball and therefore a high and not constant sliding and therefore a high energy loss.

It is therefore object of the present invention to provide a wave generator that avoids the above disadvantages and allows high running precision with low risk of failure.

This object is solved by a wave generator according to claim 1 as well as a strain wave gearing with such a wave generator according to claim 9.

The wave generator comprises an oval or elliptical inner ring and an oval or elliptical outer ring. Balls are arranged between the two rings and roll on raceways which are arranged on the two rings.

To allow minor sliding and friction losses as well as high bending stiffness and low maximum contact pressure with the raceways, the balls each have four contact points with the raceways. This means that each ball has a total of four contact points, i.e., two contact points per ring. In the contact point, the respective raceway and the ball have the same tangent and the radius of curvature, i.e., the distance between the center of the circle of curvature of the raceway and the contact point, is perpendicular to this tangent. In contrast to deep groove ball bearings which have been used so far, these four contact points distribute the contact pressure, thereby reducing contact stresses and hence wear, friction and other surface damage.

Conventional four-point contact ball bearings, which can be used as deep groove ball bearings for the wave generator, also have four contact points, but these are only theoretically present. In operation, only two of the four theoretical contact points are active, which leads to a high contact pressure at these two active contact points. In contrast to that, in the herein suggested wave generator, four contact points are always active, which means that the contact pressure is better distributed. A conventional four-point contact ball bearing further has reduced contact stiffness in both axial and radial directions, since the direction of the normal of the contact points is not aligned with the axial or radial axis. Furthermore, such a bearing requires a high axial and/or radial preload to be able to support radial loads.

To achieve this, the wave generator is divided in cross-section by the axis of rotation of a ball and an axis perpendicular to the axis of rotation of the ball into four quadrants arranged in a clockwise direction. The axis of rotation of the ball is seen here as a notional axis of rotation at standstill. In operation, the axis of rotation of the ball is not fixed but can move or shift.

The raceway of the oval outer ring lies in the first and second quadrants and the raceway of the oval inner ring lies in the third and fourth quadrants. The center of the radius of curvature of the raceway of the first quadrant is in the third quadrant, the center of the radius of curvature of the raceway of the second quadrant is in the fourth quadrant, the center of the radius of curvature of the raceway of the third quadrant is in the first quadrant, and the center of the radius of curvature of the raceway of the fourth quadrant is in the second quadrant. Each of the four contact points of a ball is located in one of the four quadrants. This special arrangement ensures that each ball with its raceways always has four contact points and that these contact points are maintained even under load. In a conventional four-point contact ball bearing, only two or at most three contact points are loaded during loaded operation. The four contact points thus generate a lower contact pressure per contact point with the ball, which can reduce wear of the wave generator, for example, while at the same time radial and axial loads can be accommodated due to the arrangement of the contact points.

In addition to reducing the contact pressure, the kinematics achieved by the four contact points also reduce the sliding of the balls in the wave generator. This allows a higher preload in the wave generator, which at the same time permits greater running precision without increasing the load on the oval inner ring or the oval outer ring. Alternatively, the preload and thus the running precision can be kept at the current level, but with the advantage of a lower risk of failures in the rings.

According to an embodiment, the intersection point of the two radii of curvature of the raceway of the oval inner ring lies on an axis perpendicular to the axis of rotation of the ball, and the intersection point of the two radii of curvature of the raceway of the oval outer ring also lies on an axis perpendicular to the axis of rotation of the ball. These axes may also be a common axis, in particular the axis perpendicular to the axis of rotation and passing through the center of the ball. Also, the intersection points may lie on the axis of rotation. Each raceway thus has two radii of curvature whose centers do not coincide, so that each raceway consists of two segments between which there is a transition. The transition between the two raceways or the contact line of the two raceways lies on a plane which passes through the center of the ball and is perpendicular to the imaginary axis of rotation of the ball. These two radii of curvature and their special arrangement ensure that the ball always has four points of contact with the raceways. The two radii of curvature can be different or identical.

According to a further embodiment, the radii of curvature are identical. This results in a symmetrical distribution of the radii of curvature and their centers among the four quadrants. This symmetrical arrangement distributes the load evenly over the four contact points between the balls and the raceways.

According to further embodiment, the contact points are arranged offset from the axis perpendicular to the axis of rotation of the ball. This means that the contact points are preferably not located on the axis of rotation of the ball and on the axis perpendicular to the axis of rotation of the ball. In this way, the wave generator can be prevented from behaving like a conventional deep groove ball bearing that has only two contact points, which would reduce radial or axial stiffness. Furthermore, radial or axial loads can be supported by the wave generator in a defined manner directly from the beginning of the load, in contrast to a conventional deep groove ball bearing, which has one contact point on each of the raceways. In the same way, axial or radial loads can be supported in a defined manner directly from the beginning of the load, in contrast to a ball bearing which also has a contact point on one of the axes.

According to a further embodiment, the contact points are arranged in a range of ±20°,preferably ±10° around the axis which is perpendicular to the axis of rotation of the ball. The contact points between the ball and the raceways can vary within this range depending on the application. Due to this arrangement, the four contact points create a special kinematics of the balls, since the axis of rotation of the balls, even during a load, always remains perpendicular to the axis around which the contact points are arranged.

According to an embodiment, the radius of curvature is a variable radius. This means that the respective raceways can be circular arc segments, but also ellipses or ovals in general.

The oval inner ring and/or the oval outer ring can each be formed as a split ring, with a preloading mechanism being provided to control the contact points between the ball and the raceways. By preloading the respective ring, the preload of the contact points can be adjusted by adjusting the clearance between the parts of the split ring.

This has the advantage that the preload required in the wave generator can be easily achieved by installing the split inner or outer ring with appropriate preload, which is not possible in previous wave generators. During assembly, for example, the outer ring with the rolling elements, i.e., balls, is installed first, followed by the first part of the split inner ring. Then the correct preload can be measured, and the second part of the split inner ring can be installed accordingly. If a split outer ring is used, the assembly is carried out in the same way. In contrast to previous wave generators, it is thus possible to better distribute the load in a simple and convenient way due to the four contact points, and also to introduce a required preload into the wave generator in a simple way.

In particular, the wave generator described herein provides a good radial load stiffness and a reduced wear behavior due to a little sliding behavior.

According to a further aspect, a strain wave gearing comprising a wave generator as described above is provided. The strain wave gearing further comprises a deformable ring, also called flex-spline, arranged around the wave generator, which may be a cylindrical bushing or cylinder having external teeth, and a rigid cylindrical outer ring, also called circular spline, having internal teeth. The teeth of the deformable ring and the cylindrical outer ring are configured to mesh with each other. When the wave generator is driven and rotates in the deformable ring, the deformable ring is elastically ovally deformed by contact with the wave generator according to its oval shape. The external teeth of the deformable ring thus mesh with the internal teeth of the cylindrical outer ring at two opposite points.

Such a strain wave gearing can be used, for example, in robots that require very precise control of the motion sequences and therefore of the joints in which bearings are used. The wave generator can be used, for example, in a robot application to connect successive arms or arm parts.

Further advantages and advantageous embodiments are given in the description, the drawings, and the claims. In particular, the combinations of features given in the description and in the drawings are purely exemplary, so that the features can also be present individually or in other combinations.

In the following, the invention will be described in more detail with reference to exemplary embodiments shown in the drawings. In this context, the exemplary embodiments and the combinations shown in the exemplary embodiments are purely exemplary and are not intended to define the scope of protection of the invention. This is defined solely by the appended claims.

It shows:

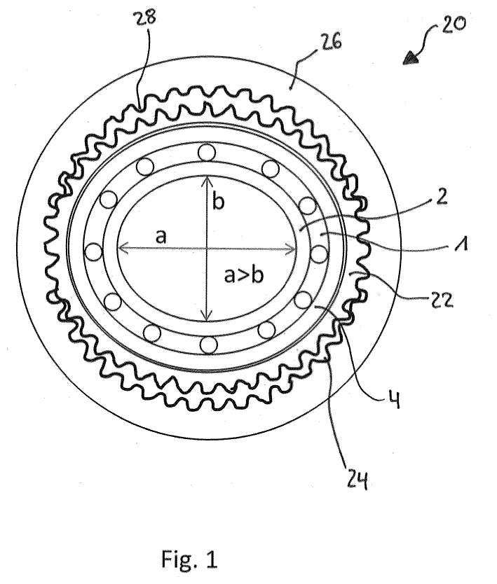

FIG. 1: a schematic view of a strain wave gearing with a wave generator;

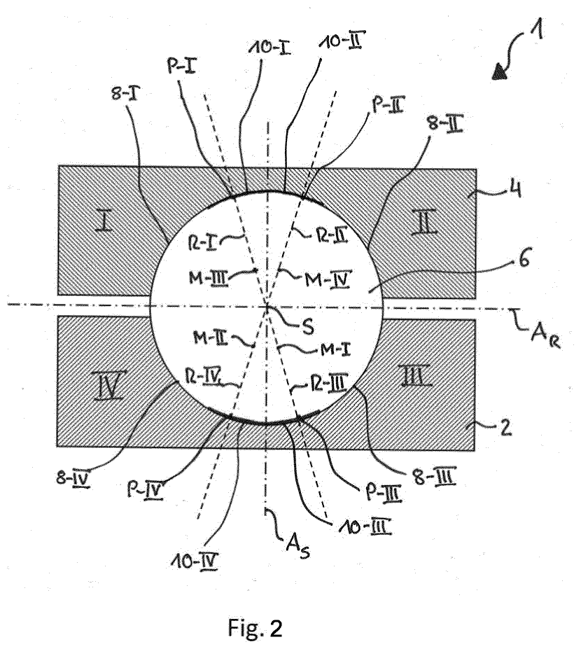

FIG. 2: a schematic cross-sectional view of a first embodiment of the wave generator of FIG. 1;

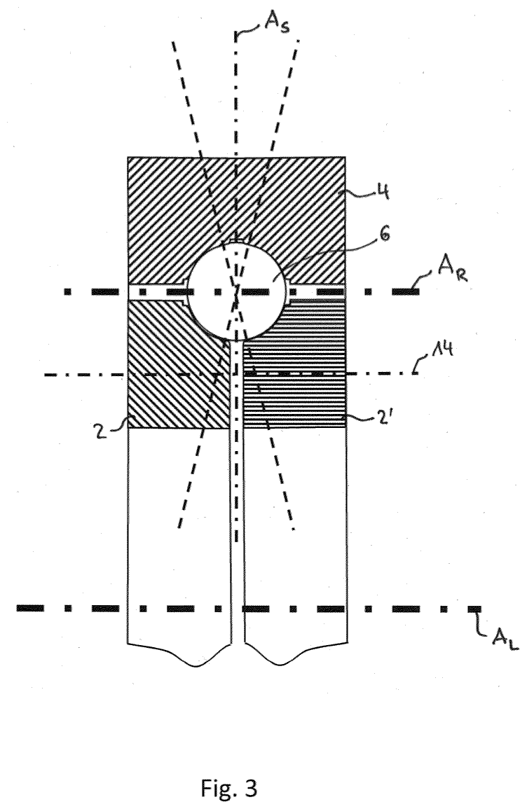

FIG. 3: a schematic cross-sectional view of a second embodiment of the wave generator of FIG. 1 with split inner ring; and

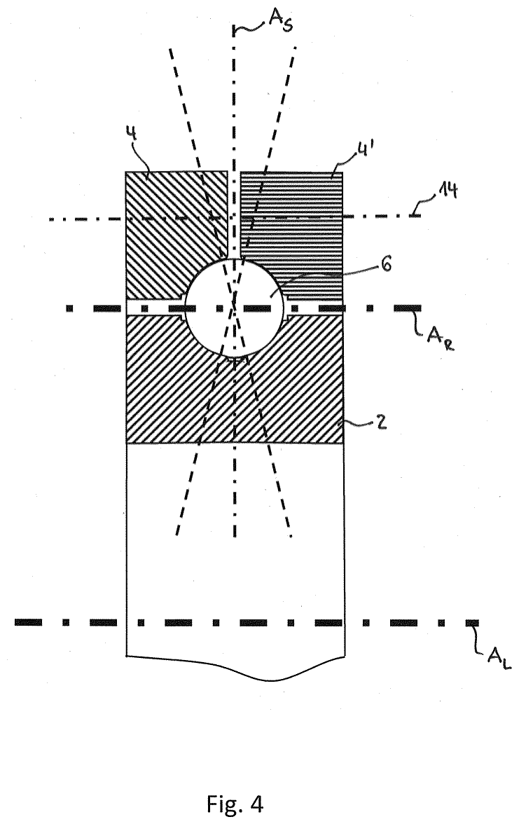

FIG. 4: a schematic cross-sectional view of a third embodiment of the wave generator of FIG. 1 with a split outer ring.

In the following, identical or functionally equivalent elements are marked with the same reference signs.

FIG. 1 shows a strain wave gearing 20 with a wave generator 1 arranged in an elastically deformable ring 22. This ring 22 may be a cup or a bushing, i.e., may be closed at one side. Alternatively, the ring may be a toothed cylinder having no bottom, as it would be the case for a cup or bushing. The ring 22 is in turn surrounded by a rigid cylindrical outer ring 26. The ring 22 has external teeth 26 and is elastically deformable in an oval or elliptical shape.

The wave generator 1 consists of an oval inner ring 2 and an oval outer ring 4, between which balls 6 are arranged. When the wave generator rotates, the ring 22, e.g., the bushing, is ovally deformed according to the oval shape of the outer ring 4 which is in contact with the ring 22. In this way, the external teeth 24 of the ring 22 are brought into contact with and mesh with the internal teeth 28 of the cylindrical outer ring 26 at two opposing locations.

Since the wave generator 1 is constantly deformed, the outer ring 4 in particular, which is in contact with the ring 22, experiences a dynamically alternating deformation at all locations of the ring 4. The rings 2, 4 of the wave generator are therefore exposed to high loads, which increases both the risk of failure and the need for very high material qualities. At the same time, the wave generator 1 has to run under preload in order to ensure a minimum difference between the rotation of the externally driven inner ring 2 of the wave generator 1 and the outer ring 4 of the wave generator 1 driving the oval ring 22. To achieve this, a wave generator 1 is used as described below.

FIG. 2 shows the wave generator 1 with the oval inner ring 2 and the oval outer ring 4. Balls 6 are arranged between the rings 2, 4 as rolling elements. The balls 6 roll on raceways 8 arranged on the rings 2, 4.

In the wave generator 1 shown in FIG. 2, the raceways 8 can be divided notionally into four quadrants I, II, III, IV. The division into the four quadrants I, II, III, IV is made by the axis of rotation A_{R} of the ball and an axis A_{S} which is perpendicular to the axis of rotation A_{R}. The raceway of the outer ring 4 is formed by two segments 8-I, 8-II and lies in the first and second quadrants I, II and the raceway of the inner ring 2 is formed by two raceway segments 8-III and 8-IV and lies in the third and fourth quadrants III, IV.

The ball 6 comes into contact with the raceways 8-I, 8-II at two contact points P-I, P-II located in two contact zones 10-I and 10-II and with the raceways 8-III and 8-IV at two contact points P-III, P-IV located in the contact zones 10-III and 10-IV. To ensure that the ball 6 contacts the raceways 8 at the contact points P-I, P-II, P-III, P-IV, the raceways 8 have a special design: The center M-I of the radius of curvature R-I of the raceway segment 8-I lies in the third quadrant III, the center M-II of the radius of curvature R-II of the raceway segment 8-II lies in the fourth quadrant IV, the center M-III of the radius of curvature R-III of the raceway segment 8-III lies in the first quadrant I, and the center M-IV of the radius of curvature R-IV of the raceway segment 8-IV lies in the second quadrant II.

In the embodiment shown in FIG. 2, the intersection point of the radii of curvature R-I, R-II of the first and second quadrants I, II lies on the axis A_{S} and the intersection point of the radii of curvature R-III, R-IV of the third and fourth quadrants III, IV also lies on the axis A_{S}. However, the intersection point may also not lie on the axis A_{S}. The radius of curvature R is understood here as the radius defining the curvature, i.e., the distance between the raceway 8 and the center M. In particular, as shown in FIG. 1, the straight line through M-I and M-III intersects the straight line through M-II and M-IV at the intersection point S. In the case shown here, the intersection point S lies at the same time on the intersection point of the axis of rotation A_{R} and the axis A_{S}, but this is not mandatory. This specific design of the radii of curvature R of the raceways 8 ensures that the ball 6 contacts the raceways 8 at the contact points P-I, P-II, P-III, P-IV. The contact points P-I, P-II, P-III, P-IV are located in the contact zones 10 within a range of ±20°, in particular ±10° about the axis A_{S}.

In order to ensure that the wave generator 1 cannot accommodate only axial or radial loads, the contact points P-I, P-II, P-III, P-IV are always offset from the axis A_{S}. In this way, the ball 6 always has four contact points P-I, P-II, P-III, P-IV with the raceways 8, which are respectively located in the contact zones 10-I, 10-II, 10-III, and 10-IV, thus achieving good radial load stiffness and good load and pressure distribution and thus low wear behavior.

The wave generator 1 can be realized in further configurations, as shown in FIGS. 3 and 4. It should be noted that in all embodiments, the axis of rotation A_{R} is arranged parallel to the axis of rotation A_{L} of the wave generator 1. In this case, the axis A_{S}, around which the contact zones 10-I, 10-II, 10-III, and 10-IV are arranged, is perpendicular to the axis of rotation A_{L} of the wave generator 1.

As shown in FIG. 3, the wave generator 1 can be formed with a split inner ring 2, 2′. This has the advantage that a preload required in the wave generator 1 can be introduced into the wave generator 1 in a simple manner. This can be done, for example, during installation by first installing the first part 2 of the inner ring, without paying attention to the preload, and then installing the second part 2′of the inner ring, where the preload is measured and adjusted by installation of the inner ring 2′.

In this case, for example, a preloading mechanism, such as a screw connection, can be used which acts in the direction of line 14. The preloading mechanism serves to control the contact points P-I, P-II, P-III, P-IV or contact zones 10 between the ball 6 and the raceways 8 during the installation of the inner ring 2′ and, if necessary, to adjust them afterwards. By preloading the ring 2, 2′, the preloading of the contact points P-I, P-II, P-III, P-IV can be adjusted by adjusting the clearance between the parts of the split ring 2, 2′.

Alternatively, the outer ring 4 can also be split, as shown in FIG. 4. In this case, the outer ring comprises a first part 4 and a second part 4′. As described with respect to the split inner ring 2, 2′, the split outer ring 4, 4′ can also be used to adjust and set the preload required in the wave generator 1 along the line 14. A preloading mechanism can also be used, which, after the installation of the first part 4, sets the required preload during the installation of the second part 4′. In contrast to previous wave generators, which are designed without split rings, the wave generator 1 proposed here thus offers not only the advantage of better load distribution due to the four contact points, but also the additional advantage of easier setting of the required preload.

The wave generator described herein can also achieve good radial and axial load stiffness and low wear behavior due to lower friction or reduced sliding behavior, respectively.

### LIST OF REFERENCE SIGNS

1 wave generator
2, 2′ oval inner ring
4,4′ oval outer ring
6 balls
8 raceways
10 contact zones
14 preload mechanism
20 strain wave gearing
22 ring
24 external teeth
26 cylindrical outer ring
28 internal teeth
I, II, III, IV quadrants
A_{L} axis of rotation of the wave generator
A_{R} axis of rotation of the ball
A_{S} axis perpendicular to the axis of rotation of the ball
M center of the radius of curvature
P contact points
R radius of curvature
S intersection point

1. A strain wave gearing comprising:
a wave generator,
a deformable cylindrical ring with external teeth arranged around the wave generator, and
a rigid cylindrical outer ring with internal teeth meshed with the external teeth of the deformable cylindrical ring,
wherein the wave generator includes an oval inner ring having a raceway and an oval outer ring having a raceway and a plurality of balls arranged between the raceway of the oval inner ring and the raceway of the oval outer ring
wherein the wave generator is notionally divided in cross-section by an axis of rotation of a ball and an axis perpendicular to the axis of rotation of the ball into four quadrants which are arranged clockwise,
wherein the ball has two contact points with the raceway of the oval inner ring and two contact points with the raceway of the oval outer ring,
wherein each contact point lies in one of the four quadrants,
wherein the raceway of the oval outer ring lies in the first and in the second quadrant and the raceway of the oval inner ring lies in the third and in the fourth quadrant,
wherein a center of a radius of curvature of the raceway of the first quadrant lies in the third quadrant, wherein a center of a radius of curvature of the raceway of the second quadrant lies in the fourth quadrant, wherein a center of a radius of curvature of the raceway of the third quadrant lies in the first quadrant, and wherein a center of a radius of curvature of the raceway of the fourth quadrant lies in the second quadrant,
wherein each of the contact points is offset from the axis perpendicular to the axis of rotation of the ball, and
wherein each of the contact points is located in a range of ±10° from the axis perpendicular to the axis of rotation of the ball.

2. The strain wave gearing according to claim 1,
wherein an intersection point of the two radii of curvature of the raceway of the oval inner ring lies on the axis perpendicular to the axis of rotation of the ball and wherein an intersection point of the two radii of curvature of the raceway of the oval outer ring lies on the axis perpendicular to the axis of rotation of the ball.

3. The strain wave gearing according to claim 2, wherein the radii of curvature are identical.

4-5 (canceled)

6. The strain wave gearing according to claim 2, wherein the radius of curvature of the raceway of the oval inner ring is a variable radius and the radius of curvature of the raceway of the oval outer ring is a variable radius.

7. The strain wave gearing according to claim 2, wherein the oval inner ring and/or the oval outer ring is formed as a split ring, and wherein a pre-loading mechanism is provided to control the contact points the ball and the raceways.

8. The strain wave gearing according to claim 2, wherein the axis of rotation of the ball is perpendicular to the axis of rotation of the wave generator.

9. (canceled)

10. The strain wave gearing according to claim 2,
wherein the oval inner ring is formed as one piece and the oval outer ring is formed as one piece.
